(19) United States
(12) Patent Application Publication
(10) Pub. No.: US 2014/0280561 A1
(43) Pub. Date: Sep. 18, 2014

(54) SYSTEM AND METHOD OF DISTRIBUTED EVENT BASED DIGITAL IMAGE COLLECTION, ORGANIZATION AND SHARING

(71) Applicant: FUJIFILM NORTH AMERICA CORPORATION, Valhalla, NY (US)

(72) Inventor: Charles L. DuBois, Rochester, NY (US)

(73) Assignee: FUJIFILM North America Corporation, Valhalla, NY (US)

(21) Appl. No.: 13/842,256

(22) Filed: Mar. 15, 2013

(51) Int. Cl. H04L 29/08

(52) U.S. Cl. CPC H04L 67/10
USPC 709/204

(57) ABSTRACT

A system and method for distributed collection, organization and sharing over the web of digital images captured and displayed by camera equipped computing devices. In one aspect, digital images are collected by a single camera device and are organized into one or more albums and sub-albums. Albums are related to an occasion. Sub-albums relate to moments within an occasion. A user can invite friends to contribute photos and are provided the ability to upload images to an album server. Before being uploaded, photos are tagged and stored in a database. In another aspect, digital images are collected from multiple camera devices capturing digital images of multiple moments occurring within a single occasion. The method then organizes those images so that images correlating to each moment are grouped together. In both instances, the method further provides for pre-loaded or user-generated moments to aid in capturing of the digital images.

### FIELD OF THE INVENTION

The present invention relates to the field of digital image organization, and more particularly relates to a system and method of distributed event based digital image collection, organization and sharing over the web.

### BACKGROUND OF THE INVENTION

The use of digital cameras, mobile devices, and tablets to capture and store images is well known. These devices are generally used for momentous occasions such as vacations, weddings, parties and the like. Further, digital cameras are becoming even more ubiquitous as nearly all handheld mobile devices incorporate at least one digital camera in the device. As more and more digital photographs are being taken, a need has developed to systematically organize these photographs for easy viewing and sharing. Additionally, momentous occasions such as weddings frequently have multiple individuals taking photographs throughout the event. Often, the person or persons featured in that event (i.e., the bride and groom during a wedding) wish to collect photographs from friends and family to commemorate that occasion. The sheer volume of images received can make it unruly or even impossible to collect and organize those photographs in a coherent manner. Thus, what should be a happy and festive time turns to frustration and annoyance.

One attempt to simplify taking of photographs involves a template having recommended photographs to be taken. For instance, should one travel to London, England, a template will provide a list of a number of locations and/or objects which a person should visit while in London, for instance Parliament, Buckingham Palace, Tower of London, the Tower Bridge and St. Paul's Cathedral. To commemorate a visit to the Tower a London, the visitor takes the requisite photograph(s) as recommended by the template and then checks or strikes that recommendation from the template. Thus, at the end of the vacation, the photographer has an organized collection of photographs as outlined by the template.

Nevertheless, certain drawbacks exist when attempting to collect and organize photographs for a single event over a moderately lengthy period of time, for instance the growth of a child over the course of a year. Improperly labeled or disorganized collections of photographs may lead to lost memories. Also, moments may arise which are not provided by a template and images of these moments will fail to be organized. Additionally, collecting and organizing photographs from multiple sources of individual moments within a single occasion (such as a wedding) requires individual attention to each photograph to ensure it is properly cataloged. Not only is this time-consuming, it may also lead to misidentified images or erroneous compilations.

Accordingly, what is needed is a system and method for providing occasion-based organization of photographs for occasions which extend for a moderate length of time. What is further needed is a system and method for collecting and organizing photographs for multiple moments within a single occasion from a number of different camera devices. The present invention fills these needs as well as other needs.

### SUMMARY OF THE INVENTION

The present invention is a system and method for distributed collection, organization and sharing of digital images captured and displayed by a camera equipped computing device. In one aspect, the digital images are collected by a single camera device over a period of time and are organized into one or more albums and sub-albums. Albums are related to an event or occasion in the life of the user. Sub-albums or sub-events relate to moments within an occasion. A user can invite friends to contribute photos to any number of albums and are provided the ability to upload images to an album server over the web. Before being uploaded, photos are tagged and stored in a database at the album server. In another aspect, the digital images are collected from multiple camera devices all capturing digital images of multiple moments occurring within a single occasion where the method then organizes those images so that images correlating to each moment within the occasion are grouped together. In both instances, the method further provides for pre-loaded or user-generated moments to aid in capturing of the digital images for a selected occasion.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the system and method of the present invention;

FIG. 2 is a high level block diagram illustrating an example tablet/mobile device incorporating the system and method of the present invention;

FIG. 3 is a block diagram illustrating an example network that includes the components and participants that make up the distributed event based digital image collection, organization and sharing system;

FIG. 4 is an example screen shot illustrating the launch of an example application embodying the system and method of the invention;

FIG. 5 is an example screen shot illustrating the creation of an album or event;

FIG. 6 is an example screen shot illustrating the creation of an album or event using built-in occasion selections;

FIG. 7 is an example screen shot illustrating the naming of an album or event at the time of creation;

FIG. 8 is an example screen shot illustrating the sharing of one or more albums with friends;

FIG. 9 is an example screen shot illustrating receipt by a friend of an invitation to share an album;

FIG. 10 is an example screen shot illustrating the confirmation of message transmission;

FIG. 11 is an example screen shot illustrating the creation of a new occasion;

FIG. 12 is an example screen shot illustrating the selection of a current album in which to organize digital images and rating of ‘best’ photos;

FIG. 13 is an example screen shot illustrating the selection of a moment to which to add digital images;

FIG. 14 is an example screen shot illustrating the choice of taking a picture or selecting from a photo gallery or camera roll;

FIG. 15 is an example screen shot illustrating the selection of a digital image from a photo gallery;

FIG. 16 is an example screen shot illustrating the creation of moments or sub-events; and

FIG. 17 is an example screen shot illustrating friends contributing their digital images to an album.

### DETAILED DESCRIPTION OF THE INVENTION

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in any combination of one or more programming languages, including an object oriented programming language such as Java, Python, Smalltalk, C++, C# or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The invention is operational with numerous general purpose or special purpose computing system environments or configurations. Examples of well-known computing systems, environments, and/or configurations that may be suitable for use with the invention include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

A block diagram illustrating an example computer processing system adapted to implement the digital image collection, organization and sharing system of the present invention is shown in FIG. 1. The exemplary computer processing system, generally referenced 10, for implementing the invention comprises a general purpose computing device 11. Computing device 11 comprises central processing unit (CPU) 12, host/PIC/cache bridge 20 and main memory 24.

The CPU 12 comprises one or more general purpose CPU cores 14 and optionally one or more special purpose cores 16 (e.g., DSP core, floating point, etc.). The one or more general purpose cores execute general purpose opcodes while the special purpose cores executes functions specific to their purpose. The CPU 12 is coupled through the CPU local bus 18 to a host/PCI/cache bridge or chipset 20. A second level (i.e. L2) cache memory (not shown) may be coupled to a cache controller in the chipset. For some processors, the external cache may comprise an L1 or first level cache. The bridge or chipset 20 couples to main memory 24 via memory bus 20. The main memory comprises dynamic random access memory (DRAM) or extended data out (EDO) memory, or other types of memory such as ROM, static RAM, flash, and non-volatile static random access memory (NVSRAM), bubble memory, etc.

The computing device 11 also comprises various system components coupled to the CPU via system bus 26 (e.g., PCI). The host/PCI/cache bridge or chipset 20 interfaces to the system bus 26, such as peripheral component interconnect (PCI) bus. The system bus 26 may comprise any of several types of well-known bus structures using any of a variety of bus architectures. Example architectures include Industry Standard Architecture (ISA) bus, Micro Channel Architecture (MCA) bus, Enhanced ISA (EISA) bus, Video Electronics Standards Associate (VESA) local bus and Peripheral Component Interconnect (PCI) also known as Mezzanine bus.

Various components connected to the system bus include, but are not limited to, non-volatile memory (e.g., disk based data storage) 28, video/graphics adapter 30 connected to display 32, user input interface (I/F) controller 31 connected to one or more input devices such mouse 34, tablet 35, microphone 36, keyboard 38 and modem 40, network interface controller 42, peripheral interface controller 52 connected to one or more external peripherals such as printer 54 and speakers 56. The network interface controller 42 is coupled to one or more devices, such as data storage 46, remote computer 48 running one or more remote applications 50, via a network 44 which may comprise the Internet cloud, a local area network (LAN), wide area network (WAN), storage area network (SAN), etc. A small computer systems interface (SCSI) adapter (not shown) may also be coupled to the system bus. The SCSI adapter can couple to various SCSI devices such as a CD-ROM drive, tape drive, etc.

The non-volatile memory 28 may include various removable/non-removable, volatile/nonvolatile computer storage media, such as hard disk drives that reads from or writes to non-removable, nonvolatile magnetic media, a magnetic disk drive that reads from or writes to a removable, nonvolatile magnetic disk, an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

A user may enter commands and information into the computer through input devices connected to the user input interface 31. Examples of input devices include a keyboard and pointing device, mouse, trackball or touch pad. Other input devices may include a microphone, joystick, game pad, satellite dish, scanner, etc.

The computer 11 may operate in a networked environment via connections to one or more remote computers, such as a remote computer 48. The remote computer may comprise a personal computer (PC), server, router, network PC, peer device or other common network node, and typically includes many or all of the elements described supra. Such networking environments are commonplace in offices, enterprise-wide computer networks, intranets and the Internet.

When used in a LAN networking environment, the computer 11 is connected to the LAN 44 via network interface 42. When used in a WAN networking environment, the computer 11 includes a modem 40 or other means for establishing communications over the WAN, such as the Internet. The modem 40, which may be internal or external, is connected to the system bus 26 via user input interface 31, or other appropriate mechanism.

The computing system environment, generally referenced 10, is an example of a suitable computing environment and is not intended to suggest any limitation as to the scope of use or functionality of the invention. Neither should the computing environment be interpreted as having any dependency or requirement relating to any one or combination of components illustrated in the exemplary operating environment.

In one embodiment, the software adapted to implement the system and methods of the present invention can also reside in the cloud. Cloud computing provides computation, software, data access and storage services that do not require end-user knowledge of the physical location and configuration of the system that delivers the services. Cloud computing encompasses any subscription-based or pay-per-use service and typically involves provisioning of dynamically scalable and often virtualized resources. Cloud computing providers deliver applications via the internet, which can be accessed from a web browser, while the business software and data are stored on servers at a remote location.

In another embodiment, software adapted to implement the system and methods of the present invention is adapted to reside on a computer readable medium. Computer readable media can be any available media that can be accessed by the computer and capable of storing for later reading by a computer a computer program implementing the method of this invention. Computer readable media includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data such as a magnetic disk within a disk drive unit. The software adapted to implement the system and methods of the present invention may also reside, in whole or in part, in the static or dynamic main memories or in firmware within the processor of the computer system (i.e., within microcontroller, microprocessor or microcomputer internal memory).

Other digital computer system configurations can also be employed to implement the system and methods of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk, CDROM, DVD, flash memory, portable hard disk drive, etc. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

### Tablet/Mobile Device Incorporating the Digital Image Collection, Organization and Sharing System

A high level block diagram illustrating an example tablet/mobile device incorporating the digital image collection, organization and sharing system of the present invention is shown in FIG. 2. The mobile device is preferably a two-way communication device having voice and/or data communication capabilities. In addition, the device optionally has the capability to communicate with other computer systems via the Internet. Note that the mobile device may comprise any suitable wired or wireless device such as multimedia player, mobile communication device, cellular phone, smartphone, PDA, PNA, Bluetooth device, tablet computing device such as the iPad, etc. For illustration purposes only, the device is shown as a mobile device, such as a cellular based telephone, smartphone or superphone. Note that this example is not intended to limit the scope of the mechanism as the invention can be implemented in a wide variety of communication devices. It is further appreciated the mobile device shown is intentionally simplified to illustrate only certain components, as the mobile device may comprise other components and subsystems beyond those shown.

The mobile device, generally referenced 60, comprises one or more processors 62 which may comprise a baseband processor, CPU, microprocessor, DSP, etc., optionally having both analog and digital portions. The mobile device may comprise a plurality of cellular radios 102 and associated antennas 104. Radios for the basic cellular link and any number of other wireless standards and Radio Access Technologies (RATs) may be included. Examples include, but are not limited to, Code Division Multiple Access (CDMA), Personal Communication Services (PCS), Global System for Mobile Communication (GSM)/GPRS/EDGE 3G; WCDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN (WLAN) network; near field communications; UWB; GPS receiver for receiving GPS radio signals transmitted from one or more orbiting GPS satellites, FM transceiver provides the user the ability to listen to FM broadcasts as well as the ability to transmit audio over an unused FM station at low power, such as for playback over a car or home stereo system having an FM receiver, digital broadcast television, etc.

The mobile device may also comprise internal volatile storage 64 (e.g., RAM) and persistent storage 68 (e.g., ROM) and flash memory 66. Persistent storage 68 also stores applications executable by processor(s) 62 including the related data files used by those applications to allow device 60 to perform its intended functions. Several optional user-interface devices include trackball/thumbwheel which may comprise a depressible thumbwheel/trackball that is used for navigation, selection of menu choices and confirmation of action, keypad/keyboard such as arranged in QWERTY fashion for entering alphanumeric data and a numeric keypad for entering dialing digits and for other controls and inputs (the keyboard may also contain symbol, function and command keys such as a phone send/end key, a menu key and an escape key), headset 88, earpiece 86 and/or speaker 84, microphone(s) and associated audio codec or other multimedia codecs, vibrator for alerting a user, one or more cameras and related circuitry 110, 112, display(s) 122 and associated display controller 106 and touchscreen control 108. Serial ports include a micro USB port 76 and related USB PHY 74 and micro SD port 78. Other interface connections may include SPI, SDIO, PCI, USD, etc. for providing a serial link to a user's PC or other device. SIM/RUIM card 80 provides the interface to a user's SIM or RUIM card for storing user data such as address book entries, user identification, etc.

Portable power is provided by the battery 72 coupled to power management circuitry 70. External power is provided via USB power or an AC/DC adapter connected to the power management circuitry which is operative to manage the charging and discharging of the battery. In addition to a battery and AC/DC external power source, additional optional power sources each with its own power limitations, include: a speaker phone, DC/DC power source, and any bus powered power source (e.g., USB device in bus powered mode).

Operating system software executed by the processor 62 is preferably stored in persistent storage (i.e., ROM 68), or flash memory 66, but may be stored in other types of memory devices. In addition, system software, specific device applications, or parts thereof, may be temporarily loaded into volatile storage 64, such as random access memory (RAM). Communications signals received by the mobile device may also be stored in the RAM.

The processor 62, in addition to its operating system functions, enables execution of software applications on the device 60. A predetermined set of applications that control basic device operations, such as data and voice communications, may be installed during manufacture. Additional applications (or apps) may be downloaded from the Internet and installed in memory for execution on the processor. Alternatively, software may be downloaded via any other suitable protocol, such as SDIO, USB, network server, etc.

Other components of the mobile device include an accelerometer 114 for detecting motion and orientation of the device, magnetometer 116 for detecting the earth's magnetic field, FM radio 118 and antenna 120, Bluetooth radio 98 and antenna 100, Wi-Fi radio 94 including antenna 96 and GPS 90 and antenna 92.

In accordance with the invention, the mobile device 60 is adapted to implement the digital image collection, organization and sharing system as hardware, software or as a combination of hardware and software. In one embodiment, implemented as a software task, the program code operative to implement the electronic catalog system is executed as one or more tasks running on processor 62 and either (1) stored in one or more memories 64, 66, 68 or (2) stored in local memory within the processor 62 itself.

### Distributed Digital Image Collection, Organization and Sharing System

A block diagram illustrating an example network that includes the components and participants that make up the distributed event based digital image collection, organization and sharing system is shown in FIG. 3. The network, generally referenced 130, comprises an album server 136 and related storage and database 133, authentication and account server 131 and related storage and database 143, remote photo ordering and printing server 135 and related storage and database 137, one or more social networking servers 139 and related storage and database 141, a plurality of user computers 134 all of which are connected to the Internet 132 or other wide area network. Users communicate with any of the servers via the Internet and may comprise several devices such as a computer 134, a tablet (e.g., iPad, etc.) 148 connected via Wi-Fi or through a cellular connection, desktop/laptop (via wired or wireless connection) computer 146, mobile device 142 such as a smartphone or cellular enabled wireless tablet 144 both in communication with the servers and other users via cellular network 138 (e.g., G3, G4, etc.) including base stations 140.

The distributed event based digital image collection, organization and sharing system provides the capability of creating photo albums and sharing those albums with friends whereby those friends can contribute photos to the albums. Photos taken by users and friends are uploaded to an album server where they are stored in a central location and accessible to users. A user or organizer (referred to as the organizing user) creates an album and invites one or more friends to share the album and contribute photos. The photos to be added to an album are either captured by a camera in the client device or selected from a camera roll or photo gallery on the device. The captured and/or selected photos are tagged with an album identifier before being uploaded to the album server. In one embodiment, all invited friends and the organizing user can view the contents of an album at any time. Thus, the collective contribution of digital images (i.e., photos) from one or more friends in addition to the organizing user can be leveraged to quickly build a relatively large collection of digital images related to an event or occasion.

With proper permissions granted, contents of albums can be viewed by the organizing user and invited friends on their mobile devices, laptops, desktops or other computing platforms. Users and friends can rate digital images in albums and vote for ‘best’ photos. In one embodiment, these organized ‘best’ photos can publicly be shared with friends, posted on social networking web sites, and/or sent to a photo product and printing server for printing into photo books or other photo products. Alternatively, all photos in an album can be viewed or shared with friends, posted on social networking web sites, and/or sent to a photo product and printing server for printing into photo books or other photo products.

A synchronization capability allows users and invited friends to refresh their views of shared albums. For shared albums, digital images may be uploaded at any time to the central album server and stored in the database. The synchronization mechanism detects that a photo was added to an album and updates are pushed out to all previously invited friends client devices in addition to the original organizing user.

In addition, the system enables the organizing user to (1) upload digital images to albums created by the user and those for which an invitation was received from a friend, (2) initiate a synchronization of one or more albums, and (3) manage one or more albums created by the user and optionally those for which an invitation was received from a friend.

Users and invited friends can browse those albums previously shared by the organizing user which are stored on the album server by sending requests for data (e.g., digital images) and receiving responses containing the requested data. Events are persistent in that they do not age out and are not deleted, other than intentionally by the organizing user. In practice, numerous events can be ‘active’ or ‘live’ at once. The duration of each event is independent of that of all other events. Thus, some events may be short lived such as a birthday party event that lasts a few hours, versus a ‘baby's 1^{st} year’ event which lasts over a year. Photos can be added to any event at any time by the organizing user and any invited friend. Therefore, it is contemplated that multiple albums that relate to distinct or related events may be simultaneously active.

In one embodiment, in response to user requests, the album server generates pages, and/or retrieves the digital images, which are then served to the user's device and displayed. User devices may comprise numerous types of devices and include, but are not limited to, mobile devices 158, desktops, laptops, notebooks, netbooks, etc. 160 and table devices 162. The user may connect to the server via a standalone software application or via a standard web browser with or without a browser plug-in.

Note that the system is intended for use on any computer system such as desktop computers, laptop computers, notebook computers, netbook computers, wireless mobile devices, mobile phones, etc. It is however, especially applicable for use on smartphones, tablet computers such as the Apple iPad, Android based tablets and other tablet formats as embodied in an application or ‘app’.

The system comprises software that runs on one or more server computers as well as client or user side that can be realized (1) as a standalone software application or “app” that runs on the user device (e.g., desktop, mobile device, tablet, etc.) or (2) entirely in a standard web browser. Essentially, the system functions to provide a distributed photo collection, organization and sharing capability for one or more users, especially when realized on a tablet or mobile device.

An advantage of the system is that it can be used anywhere a wireless Internet connection or mobile phone signal is available as well as on a desktop computer via a standard web browser. If a wireless internet connection or mobile phone signal is not available, the data can be stored and transmitted once a connection becomes available. The user interface provided to the user (whether standalone application or through a web browser) can be used by anyone without computer or software knowledge.

Throughout this document the term “website” is used to refer to a user-accessible network site that implements the basic World Wide Web standards for the coding and transmission of hypertext documents. These standards currently include HTML (the hypertext markup language) and HTTP (the hypertext transfer protocol). Note that the term “site” is not intended to imply a single geographic location as a website or other network site can, for example, include multiple geographically distributed computer systems that are appropriately linked together. Note that throughout this document, the terms album, occasion and event are intended to mean the same thing. Similarly, the terms sub-album, sub-event, sub-occasion and moment are all intended to refer to the same thing.

An example screen shot illustrating the launch of an example application embodying the system and method of the invention is shown in FIG. 4. In this screen shot, generally referenced 150, the home page of an example app is shown. The organizing user is presented with choices to take a photo 152 or create an album 154. Buttons are also provided to view albums 156 and invite friends 158.

An example screen shot illustrating the creation of an album or event is shown in FIG. 5. The screen shot, generally referenced 160, shows an example create album screen. The organizing user is presented with several pre-canned album names 166 and icons 164 for creating albums. For example, a wedding album, baby's 1^{st} year, etc. An add button 176 allows the creation of a custom named album if the user does not like the pre-canned names. At the bottom of the screen the user is presented with quick navigation buttons for home 168, invite friends 170, view albums 172 and take (i.e., capture) a photo 174.

An example screen shot illustrating the creation of an album or event using built-in occasion selections is shown in FIG. 6. The screen shot, generally referenced 180, provides the ability to an organizing user to save a newly named album (i.e. occasion) 182. The user is presented with a choice wheel 185 which includes a plurality of choices such as ‘wedding’ 186, in addition to an ‘add new’ button 184. Options include canceling, skipping or moving to the next screen 188. The user can create a custom named album using the ‘add’ button 189.

An example screen shot illustrating the naming of an album or event at the time of creation is shown in FIG. 7. The screen shot, generally referenced 190, shows a user creating a new album and assigning it a custom name 194. The “name your album” block 192 also includes back, invite and create album buttons 196. The user can create another custom named album using the ‘add’ button 198.

An example screen shot illustrating the sharing of one or more albums with friends is shown in FIG. 8. The screen shot, generally referenced 200, shows adding an occasion or event and sharing albums. Occasions and events are represented by albums in the system. An organizing user can choose to share one or more albums with one or more friends. Invited friends can then contribute photos to a shared album. The contribution of digital images from all friends and the original organizing user are uploaded to the album server and stored in a database. Button choices of back and invite 208 are provided to the user.

An organizing user shares 202 an album by selecting one or more friends 206 from a contact list. Contacts are listed in alphabetical order to make selection easier. The contact list may be generated from any suitable source such as the internal address book of the user (i.e. client computer), or alternatively can be culled from contact lists from one or more social networking sites such as Facebook, Google, Twitter, etc. Note that for any album there is only a single organizing user. All others that contribute and upload digital images to the album are referred to as friends or invited friends.

Once the organizing user selects the contacts she/he wishes to share an album with, invitations are sent out to those contacts via any suitable mechanism, e.g., email, text messaging, etc. Invitees then can opt to accept or reject the invitation.

An example screen shot illustrating receipt by a friend of an invitation to share an album is shown in FIG. 9. The screen shot, generally referenced 210, shows an invitation 212 being received on a friend's client device sent from the organizing user. Note that the invitation may be generated and sent by the album server, authentication server, directly from the organizing client device, or any other computing entity, depending on the implementation of the invention.

Once received, the invitee can elect to accept or reject the invitation. Upon accepting the invitation, the friend can optionally send the acceptance 214 to one or more co-invitees as well as back to the organizing user. Buttons for back and send 216 are provided to the friend.

An example screen shot illustrating the confirmation of message transmission is shown in FIG. 10. In this screen shot, generally referenced 220, an indication 222 acknowledges that the message of acceptance to the organizing user and one or more friends was sent successfully. An OK button 224 is provided.

An example screen shot illustrating the creation of a new occasion is shown in FIG. 11. The screen shot, generally referenced 280, shows the addition of a new occasion (i.e., album) 282. A circular selection wheel 284 is presented to the organizing user to choose a pre-canned album title from or provide a custom album name in space 286. Cancel, skip and next buttons 288 are also provided. Another album can be created by the organizing user using the ‘add’ button 298.

An example screen shot illustrating the selection of a current album in which to organize digital images and rating of ‘best’ photos is shown in FIG. 12. The screen shot, generally referenced 270, shows a list of albums 278 available to be shared by the organizing user. Albums are optionally organized by year 274 and month 276. A button 272 allows the user to create a new album if desired. Once created or selected for sharing, the user than selects invitees (i.e. friends) to whom an invitation should be sent. Once invited, friends can upload digital images to the album which is stored on the album server database.

An example screen shot illustrating the selection of a moment to which to add digital images is shown in FIG. 13. The screen shot, generally referenced 230, shows a list 234 of moments (i.e., sub-events or sub-albums) to which digital images are to be tagged and stored. The number 236 of photos currently existing in that moment is also shown. A user or friend is also provided a button to add one or more digital images to a moment sub-album. Button 232 can be used to create a new moment.

In one embodiment, although a hierarchical album/sub-album structure is presented to the user and friends, the underlying photo database on the album server may be non-hierarchical (i.e., flat). Each album and sub-album is assigned a unique album identifier which is used by the system to uniquely identify an album. It is this album identifier which is used to tag a digital image before it is uploaded to the album server. The album identifier can also be used to tag a digital image related to a sub-event related to a particular occasion, album or sub-album. For example, in the case of a wedding album, a digital image could be auto-tagged with separate image identifiers related to the sub-events that take place during a wedding, such as, but not limited to, cake cutting, first dance, etc. Further, instead of, or in addition to being tagged to a sub-event, it should be understood that an image identifier could take the form of a time stamp that will allow uploaded digital images to be organized and sorted based on time parameters. For instance, if it is known that the cake cutting took place between 7:00-7:15 pm, then all digital images with image identifiers in that time frame would be sorted into the cake cutting sub-event.

An example screen shot illustrating the choice of taking a picture or selecting from a photo gallery or camera roll is shown in FIG. 14. The screen shot, generally referenced 240, provides two choices to add digital images 242 to an album or sub-album. One option 244 is to choose a digital image from an internal camera roll or photo gallery in the client device. The second option 246 is to capture a new digital image using the built-in camera in the client device. For example, most smartphones today have built-in cameras, with many having both front and rear facing cameras.

An example screen shot illustrating the selection of a digital image from a photo gallery is shown in FIG. 15. The screen shot, generally referenced 290, displays the digital images 292 contained in the internal photo gallery or camera roll. Cancel and ‘add photo’ buttons 294 are provided. One or more photos are selected. The selected photos are tagged with the corresponding album identifier and uploaded to the album server. The album identifier could be the name of the selected album, sub-album, as well as the sub-events that are specified in the album or sub-album. They can then be shared with the organizing user and invited friends. They can be ‘pushed’ out to the organizing user and invited friends or ‘pulled’ upon receipt of a request to view the photos in an album or sub-album.

An example screen shot illustrating the creation of moments or sub-events is shown in FIG. 16. The screen shot, generally referenced 250, shows the naming 254 of a moment within an album in an ‘add moment’ 252 screen. Options include ‘cancel’ and ‘add moment’ 256. In one embodiment, the organizing user as well as the invited friends of an album can create and add moments (in additional to contributing photos to the moment).

An example screen shot illustrating friends contributing their digital images to an album is shown in FIG. 17. The moments 262 created for the example ‘wedding’ album are shown listed. The number of photos 266 in each moment is also provided. A button 264 to add photos to a moment is provided. Clicking on the ‘add photo’ button opens the ‘add photo’ screen shown in FIG. 14 described supra.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for organizing and sharing digital images, said method comprising:
creating, in response to a user command on a first device, a photo album relevant to a particular event or occasion, wherein digital images of said album are stored in web based storage;
sharing, over the web, said album with one or more friends of said user; and
enabling the transfer of digital images from said first device and one or more friend's devices to said web based album.

2. The method according to claim 1, further comprising creating, by said user, sub-albums related to sub-events or moments of said event or occasion.

3. The method according to claim 2, further comprising facilitating the creation, adding to, and deletion of albums and sub-albums by said user.

4. The method according to claim 1, further comprising enabling the viewing of digital images contained in said album on said first device and all shared devices.

5. The method according to claim 1, wherein said sharing comprises presenting said user on said first device a contact list for selecting said one or more friends to share said album with.

6. The method according to claim 1, wherein said sharing comprises presenting said user on said first device a contact list derived from one or more social media web sites said user is a member of for selecting said one or more friends to share said album with.

7. The method according to claim 1, wherein said enabling comprises transferring one or more selected digital images from a friend's device to said web based album.

8. The method according to claim 7, wherein said selected digital images are tagged with an album identifier before uploading to said web based album.

9. The method according to claim 1, wherein said sharing comprises enabling the viewing of the contents of said album on said first device and each friend's device.

10. The method according to claim 1, wherein creating comprises creating a plurality of albums, wherein each album is associated with an event or occasion, wherein each event or occasion has any desired time span and is independent of other events and occasions.

11. The method according to claim 1, wherein said digital images are captured by a digital camera in said first device, tagged with a corresponding album identifier and transferred to said album.

12. The method according to claim 1, wherein said digital images are selected from a camera roll in said first device, tagged with a corresponding album identifier and transferred to said album.

13. The method according to claim 1, wherein said digital images are captured by a digital camera in a friend's device, tagged with a corresponding album identifier and transferred to said album.

14. The method according to claim 1, wherein said digital images are selected from a camera roll in a friend's device, tagged with a corresponding album identifier and transferred to said album.

15. The method according to claim 1, wherein digital images are tagged with a corresponding album identifier before being uploaded to said web based storage.

16. The method according to claim 1, further comprising organizing and rating, by said user and said one or more friends, digital images stored in said album.

17. The method according to claim 1, further comprising providing said user and said one or more friends an ability to rate digital images stored in said album and facilitating the ordering of photo products for ‘best’ rated digital images.

18. The method according to claim 1, further comprising providing said user and said one or more friends an ability to rate digital images stored in said album and facilitating the sharing of ‘best’ rated digital images on one or more social network web sites.

19. The method according to claim 1, allowing for the creation of multiple photo albums, wherein the multiple photo albums are simultaneously active.

20. A method for organizing and sharing digital images for use on a client device, said method comprising:
sending, in response to a user command, a request to a web based server to create a first album for storage of digital images, said first album relevant to a particular event or occasion;
selecting one or more friends of said user to share said first album with;
sending an invitation to said selected friends;
tagging one or more digital images captured by said user or selected from a camera roll with a corresponding first album identifier; and
uploading said tagged digital images to said web based server.

21. The method according to claim 20, further comprising:
receiving invitations to share a second album from other client devices;
tagging one or more digital images captured by said user or selected from a camera roll with a corresponding second album identifier; and
uploading said tagged digital images to said web based server.

22. The method according to claim 20, wherein the contents of an album contains all digital images tagged with a common album identifier uploaded by said user and any friends selected by said user to share said album with.

23. The method according to claim 20, further comprising sending, in response to a user command, a request to a web based server to create a second album for storage of digital images, said second album associated with a particular sub-event or occasion moment.

24. The method according to claim 20, wherein selecting comprises presenting said user a contact list from which said user selects one or more friends to share said first album with.

25. The method according to claim 24, wherein contact list is derived from either an internal address book or friends' lists from social media web sites said user is a member of.

26. The method according to claim 20, further comprising organizing and rating, by said user and said one or more friends, digital images stored in said first album.

27. The method according to claim 20, further comprising providing said user and said one or more friends an ability to rate digital images stored in said first album and facilitating the ordering of photo products for ‘best’ rated digital images.

28. The method according to claim 20, further comprising providing said user and said one or more friends an ability to rate digital images stored in said first album and facilitating the sharing of ‘best’ rated digital images on one or more social network web sites.

29. A method for organizing and sharing digital images for use on a server, said method comprising:
receiving a request to create a photo album for storage of digital images, said album relevant to a particular event or occasion;
creating said album in a digital image database;
receiving digital images tagged with a corresponding album identifier; and
storing said received digital images in said database in accordance with said album identifier.

30. The method according to claim 29, further comprising:
receiving from clients requests for digital images associated with an album; and
retrieving and sending said requested digital images to the requesting client for viewing thereon.

31. The method according to claim 29, further comprising receiving one or more ratings from one or more client computers for digital images stored in an album.

32. The method according to claim 29, further comprising receiving product requests for photo products for ‘best’ rated digital images in an album and routing said product requests to a photo product server.

33. The method according to claim 29, further comprising receiving requests to share ‘best’ rated digital images and facilitating posting of said ‘best’ rated digital images on one or more social network web sites.

34. A computer program product for organizing and sharing digital images, the computer program product comprising:
a non-transitory, tangible computer usable storage medium having computer usable code embodied therewith, the computer usable program code comprising:
computer usable code configured for sending, in response to a user command, a request to a web based server to create a photo album for storage of digital images, said album relevant to a particular event or occasion;
computer usable code configured for selecting one or more friends of said user to share said album with;
computer usable code configured for sending an invitation to said selected friends;
computer usable code configured for tagging one or more digital images captured by said user or selected from a camera roll with a corresponding album identifier; and
computer usable code configured for uploading said tagged digital images to said web based server.
